(19) United States
(12) Patent Application Publication
(10) Pub. No.: US 2014/0156575 A1
(43) Pub. Date: Jun. 5, 2014

(54) Method and Apparatus of Processing Data Using Deep Belief Networks Employing Low-Rank Matrix Factorization

(71) Applicant: NUANCE COMMUNICATIONS, INC., Burlington, MA (US)

(72) Inventors: Tara N. Sainath, New York, NY (US); Ebru Arisoy, New York, NY (US); Bhuvana Ramabhadran, Mount Kisco, NY (US)

(73) Assignee: NUANCE COMMUNICATIONS, INC., Burlington, MA (US)

(21) Appl. No.: 13/691,400

(22) Filed: Nov. 30, 2012

(51) Int. Cl. G06N 3/08

(52) U.S. Cl. CPC G06N 3/08
USPC 706/16

(57) ABSTRACT

Deep belief networks are usually associated with a large number of parameters and high computational complexity. The large number of parameters results in a long and computationally consuming training phase. According to at least one example embodiment, low-rank matrix factorization is used to approximate at least a first set of parameters, associated with an output layer, with a second and a third set of parameters. The total number of parameters in the second and third sets of parameters is smaller than the number of sets of parameters in the first set. An architecture of a resulting artificial neural network, when employing low-rank matrix factorization, may be characterized with a low-rank layer, not employing activation function(s), and defined by a relatively small number of nodes and the second set of parameters. By using low rank matrix factorization, training is faster, leading to rapid deployment of the respective system.

### BACKGROUND OF THE INVENTION

Artificial neural networks and deep belief networks, in particular, are applied in a range of applications, including speech recognition, language modeling, image processing applications, or similar other applications. Given that the problems associated with such applications are typically complex, the artificial neural networks typically used in such applications are characterized by high computational complexity.

### SUMMARY OF THE INVENTION

According to at least one example embodiment, a computer-implemented method, and corresponding apparatus, of processing data, representing a real-world phenomenon, using an artificial neural network configured to model a real-world system or data pattern, includes: applying a non-linear activation function to a weighted sum of input values at each node of at least one hidden layer of the artificial neural network; calculating a weighted sum of input values at each node of at least one low-rank layer of the artificial neural network without applying a non-linear activation function to the calculated weighted sum, the input values corresponding to output values from nodes of a last hidden layer among the at least one hidden layers; and generating output values by applying a non-linear activation function to a weighted sum of input values at each node of an output layer, the input values at each node of the output layer being output values from nodes of a last low-rank layer of the at least one low-rank layer of the artificial neural network.

According to another example embodiment, the at least one low-rank layer and associated weighting coefficients are obtained by applying an approximation, using low rank matrix factorization, to weighting coefficients interconnecting the last hidden layer to the output layer in a baseline artificial neural network that does not include the low-rank layer. The number of nodes of the at least one low-rank layer are fewer than the number of nodes of the last hidden layer. The computer-implemented method may further include, in a training phase, adjusting weighting coefficients associated with nodes of the at least one hidden layer, the at least one low-rank layer, and the output layer based at least in part on outputs of the artificial neural network and training data. Adjusting the weighting coefficients may be performed, for example, using a fine-tuning approach, a back-propagation approach, or other approaches known in the art. The output values generated by may be indicative of probability values corresponding to a plurality of classes, the plurality of classes being represented by the nodes of the output layer.

According to yet another example embodiment, the artificial neural network is a deep belief network. Deep belief networks, typically, have a relatively large number of layers and are, typically, pre-trained during a training phase before being used in a decoding phase.

According to other example embodiments, the data may be speech data, in the case where the artificial neural network is used for speech recognition; text data, or word sequences (n-grams) with/without counts, in the case where the artificial neural network is used for language modeling, or image data, in the case where the artificial neural network is used for image processing.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A shows a system, where example embodiments of the present invention may be implemented.

FIG. 1B shows a block diagram illustrating a training phase of the deep belief network.

FIG. 2A is a diagram illustrating a representation of deep belief network employing low rank matrix factorization.

FIG. 2B is a block diagram illustrating the computational operations associated with the deep belief network of FIG. 2A.

FIG. 3A shows a block diagram illustrating potential pre- and post-processing of, respectively, input and output data.

FIG. 3B shows a diagram illustrating a neural network language model architecture.

FIGS. 4A-4D show speech recognition simulations results for a baseline DBN and a DBN employing low-rank matrix factorization.

FIG. 5 shows language modeling simulation results for a baseline DBN and a DBN employing low-rank matrix factorization.

FIG. 6 is a flow chart illustrating a method of processing data, representing a real-world phenomenon, using an artificial neural network configured to model a real-world system or data pattern according to at least one example embodiment.

### DETAILED DESCRIPTION OF THE INVENTION

A description of example embodiments of the invention follows.

Artificial neural networks are commonly used in modeling systems or data patterns adaptively. Specifically, complex systems or data patterns characterized by complex relationships between inputs and outputs are modeled through artificial neural networks. An artificial neural network includes a set of interconnected nodes. Inter-connections between nodes represent weighting coefficients used for weighting flow between nodes. At each node, an activation function is applied to corresponding weighted inputs. An activation function is typically a non-linear function. Examples of activation functions include log-sigmoid functions or other types of functions known in the art.

Deep belief networks are neural networks that have many layers and are usually pre-trained. During a learning phase, weighting coefficients are updated based at least in part on training data. After the training phase, the trained artificial neural network is used to predict, or decode, output data corresponding to given input data. Training of deep belief networks (DBNs) is computationally very expensive. One reason for this is because of the huge number of parameters in the network. In speech recognition applications, for example, DBNs are trained with a large number of output targets, e.g., 10,000, to achieve good recognition performance. The large number of output targets significantly contributes to the large number of parameters in respective DBN systems.

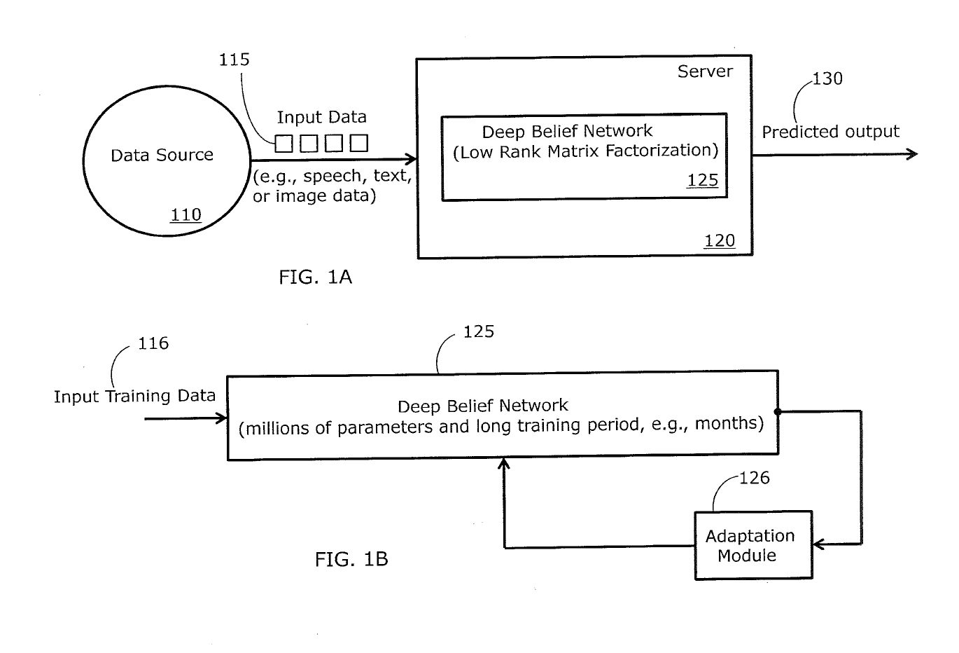

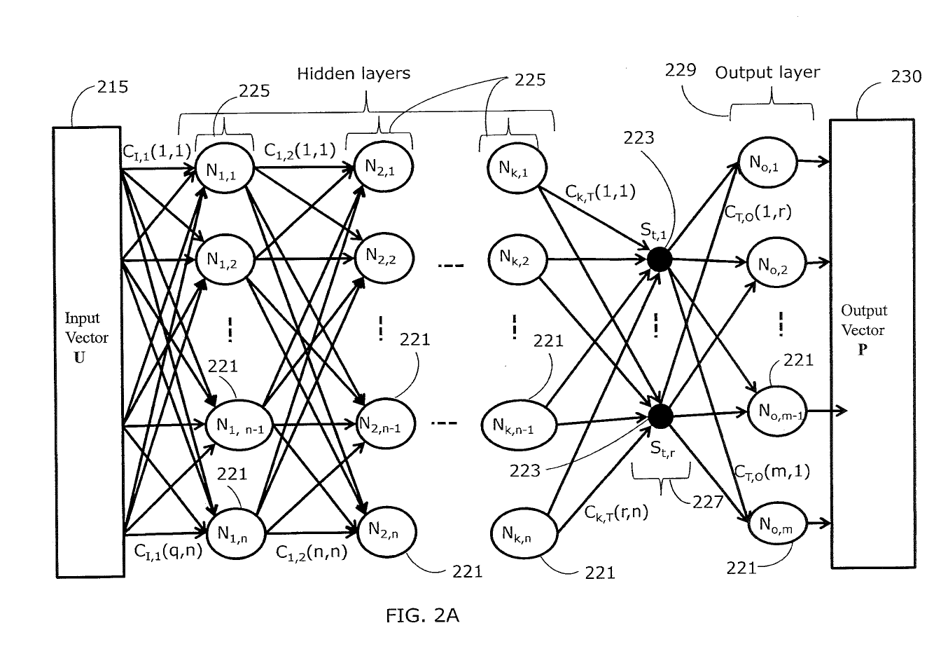

FIG. 1A shows a system, where example embodiments of the present invention may be implemented. The system includes a data source 110. The data source may be, for example, a database, a communications network, or the like. Input data 115 is sent from the data source 110 to a server 120 for processing. The input data 115 may be, for example, speech, text, image data, or the like. For example, DBNs may be used in speech recognition, in which case input data 115 includes speech signals data. In the case where DBNs are used for language modeling or image processing, input data 115 may include, respectively, textual data or image data. The server 120 includes a deep belief network (DBN) module 125. According to at least one example embodiment of the present invention, low rank matrix factorization is employed to reduce the complexity of the DBN 125. Given the large number of outputs, typically associated with DBNs, low rank factorization enables reducing the number of weighting coefficients associated with the output targets and, therefore, simplifying the complexity of the respective DBN 125. The input data 115 is fed to the DBN 125 for processing. The DBN 125 provides a predicted, or decoded, output 130. The DBN 125 represents a model characterizing the relationships between the input data 115 and the predicted output 130.

FIG. 1B shows a block diagram illustrating a training phase of the deep belief network 125. Deep belief networks are characterized by a huge number of parameters, or weighting coefficients, usually in the range of millions, resulting in a long training period, which may extend to months. During the training phase, training data is used to train the DBN 125. The training data typically includes input training data 116 and corresponding desired output training data (not shown). The input training data 116 is fed to the deep belief network 125. The deep belief network generates output data corresponding to the input training data 116. The generated output data is fed to an adaptation module 126. The adaptation module 126 makes use of the generated output data and desired output training data to update, or adjust, the parameters of the deep belief network 125. For example, the adaptation module may employ a back-propagation approach, a fine-tuning approach, or other approaches known in the art to adjust the parameters of the deep belief network 125. Once the parameters of the DBN 125 are adjusted, more, or the same, input training data 116 is fed again to the DBN 125. This process may be iterated many times until the generated output data converges to the desired output training data. Convergence of the generated output data to the desired output training data usually implies that parameters, e.g., weighting coefficients, of the DBN converged to values enabling the DBN to characterize the relationships between the input training data 116 and the corresponding desired output training data.

In example applications such as speech recognition, language modeling, or image processing, typically, a larger number of output targets are used to represent the different potential output options of a respective DBN 125. The use of larger number of output targets results in high computational complexity of the DBN 125. Output targets are usually represented by output nodes and, as such, a large number of output targets leads to even a larger number of weighting coefficients, associated with the output nodes, to be estimated through the training phase. For a given input, typically, few output targets are actually active, and the active output targets are likely correlated. In other words, active output targets most likely belong to a same context-dependent state. A context-dependent state represents a particular phoneme in a given context. The context may be defined, for example, by other phonemes occurring before and/or after the particular phoneme. The fact that few output targets are active most likely indicates that a matrix of weighting coefficients associated with the output layer has low rank. Because the matrix is low-rank, rank factorization is employed, according to at least one example embodiment, to represent the low-rank matrix as a multiplication of two smaller matrices, thereby significantly reducing the number of parameters in the network.

There have been a few attempts in the speech recognition community to reduce number of parameters in the DBN. One common approach, known as “optimal brain damage” eliminates weighting coefficients which are close to zero by reducing their values to zero. However, such approach simplifies the architecture of the DBN after the training phase is complete and, as such, the “optimal brain damage” approach does not have any impact on training time, and is mainly used to improve decoding time.

Convolutional neural networks have also been explored to reduce parameters of the DBN, by sharing weights across both time and frequency dimensions of the speech signal. However, convolutional weights are not used in higher layers, e.g., the output layer, of the DBN and, therefore, convolutional neural networks do not address the large number of parameters in the DBN due to a large number of output targets.

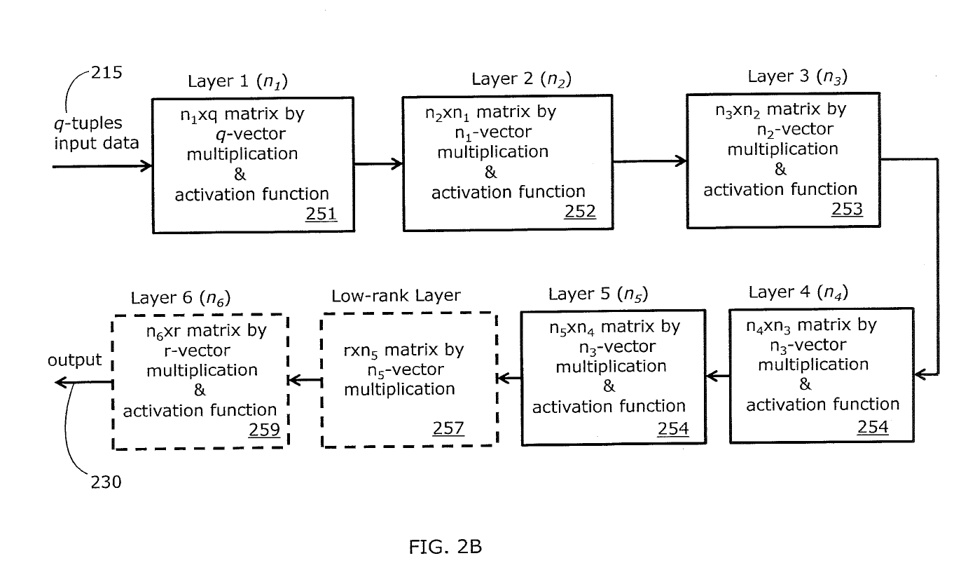

FIG. 2A is a diagram illustrating a graphical representation of an example deep belief network employing low rank matrix factorization. The DBN 125 includes one or more hidden layers 225, a low-rank layer 227, and an output layer 229. Input data tuples 215 are fed to nodes 221 of a first hidden layer. At each node 221, the input data is weighted using weighting coefficients, associated with the respective node, and the sum of the corresponding weighted data is applied to a non-linear activation function. The output from nodes of the first hidden layer is then fed as input data to nodes of a next hidden layer. At each successive hidden layer, output data from nodes of a previous hidden layer are fed as input data to nodes of the successive hidden layer. At each node of the successive hidden layer, input data is weighted, using weighting coefficients corresponding to the respective node, and a non-linear activation function is applied to the sum of the weighted coefficients. The example DBN 125 shown in FIG. 2A has k hidden layers, each having n nodes, where k and n are integer numbers. A person skilled in the art should appreciate that a DBN 125 may have one or more hidden layers and that the number of nodes in distinct hidden layers may be different. For example, the k hidden layers in FIG. 2A may have, respectively, n₁, n₂, nₖ number of nodes, where n₁, n₂, . . . , and nₖ are integer numbers. According to at least one example embodiment, output data from the last hidden layer, e.g., the k^{th} hidden layer, is fed to nodes of the low-rank layer 227. The number of nodes of the low-rank layer, e.g., r nodes, is typically substantially fewer than the number of nodes in the last hidden layer. Also, nodes of the low-rank layer 227 are substantially different from nodes of hidden layers 225 in that no activation function is applied within nodes of the low-rank layer 227. In fact, with each node of the low-rank layer, input data values are weighted using weighting coefficients, associated with a respective node, and the sum of the weighting coefficients is output. Output data values from different nodes of the low-rank layer 227 are fed, as input data values, to nodes of the output layer 229. At each node of the output layer 229, input data values are weighted using corresponding weighting coefficients, and a non-linear activation function is applied to the sum of the weighted coefficients providing output data 230 of the DBN 125. According to at least one example embodiment, the nodes of the output layer 229 and corresponding output data values represent, respectively, the different output targets and their corresponding probabilities. In other words, each of the nodes in the output layer 229 represents a potential output state. An output value of a node, of the output layer 229, represents the probability of the respective output state being the output of the DBN in response to particular input data 215 fed to the DBN 125.

Typical DBNs known in the art do not include a low-rank layer. Instead, output data values from the last hidden layer are directly fed to nodes of the output layer 229, where the output data values are weighted using respective weighting coefficients, and a non-linear activation function is applied to the corresponding weighted values. Since few output targets are usually active, a matrix representing weighting coefficients associated with nodes of the output layer is assumed, according to at least one example embodiment, to be low rank, and rank factorization is employed to represent the low-rank matrix as a multiplication of two smaller matrices, thereby significantly reducing the number of parameters in the network.

FIG. 2B is a block diagram illustrating computational operations associated with an example deep belief network employing low-rank matrix factorization. The DBN of FIG. 2B includes five hidden layers, 251-255, a low-rank layer 257, and an output layer 259. The five hidden layers 251-255 have, respectively, n₁, n₂, n₃, n₄, and n₅ nodes. The output layer 259 has n₆ nodes representing n₆ corresponding output targets. The input data to each node of the first hidden layer 251 has q entries, or values. The multiplications, of input data values with respective weighting coefficients, performed across all the nodes of the first hidden layer 251 may be represented as a multiplication of an n₁×q matrix, e.g., C_{I,1}, by an input data vector having q entries. At each node of the first hidden layer, a non-linear activation function is applied to the sum of the corresponding weighted input values. At the second hidden layer 252, the multiplications of input data values with respective weighting coefficients, performed across all the respective nodes, may be represented as a multiplication of an n₂×n₁ matrix, e.g., C_{1,2}, by a vector having n₁ entries corresponding to n₁ output values from the nodes of the first hidden layer 251. In fact, at a particular hidden layer the total number of multiplications may be represented as a matrix-vector multiplication, where the vector's entries, and the size of each row of the matrix, are equal to the number of input values fed to each node of the particular hidden layer. The size of each column of the matrix is equal to the number of nodes of the particular hidden layer.

According to at least one example embodiment, the DBN 125 includes a low-rank layer 257 with r nodes. At each node of the low-rank layer 257, input data values are weighted using respective weighting coefficients, and the sum of weighted input values is provided as the output of the respective node. The multiplications of input data values by corresponding weighting coefficients, at the nodes of the low-rank layer 257, may be represented as a multiplication of an r×n₅ matrix, e.g., C_{5,T}, by an input data vector having n₅ entries. Output data values from nodes of the low-rank layer are fed, as input data values, to nodes of the output layer 259. At each node of the output layer 259, input data values are weighted using corresponding weighting coefficients and a non-linear activation function is applied to the sum of respective weighted input data values. The output of the nonlinear activation function, at each node of the output layer 259, is provided as the output of the respective node. The multiplications of input data values by corresponding weighting coefficients, at the nodes of the output layer 259, may be represented as a multiplication of an n₆×r matrix, e.g., C_{T,O}, by an input data vector having r entries.

Typical DBNs known in the art do not include a low-rank layer 257. Instead, output data values from nodes of the last hidden layer are provided, as input data values, to nodes of the output layer, where the output data values are weighted using respective weighting coefficients, and an activation function is applied to the sum of weighted input data values at each node of the output layer. A block diagram, similar to that of FIG. 2B, but representing a typical DBN as known in that art would not have the low-rank layer block 257, and output data from the hidden layer 255 would be fed, as input data, directly to the output layer 259. In addition, in the output layer 259, the multiplications of input data values with respective weighting coefficients would be represented as a multiplication of an n₆×n₅ matrix, e.g., C_{5,6}, by a vector having n₅ entries. In other words, while a typical DBN, as known in the art, having five hidden layers and an output layer would have n₆×n₅ weighting coefficients associated with the output layer, a DBN employing low-rank matrix factorization makes use, instead, of a total of r×n₅₊n₆×r weighting coefficients at the low-rank layer 257 and the output layer 259. Furthermore, the total number of multiplications performed at the output layer of a typical DBN, as known in the art, is equal to n₆×(n₅₎². However, in a DBN employing low rank matrix factorization, as shown in FIG. 2B, the total number of multiplications performed, both at the low-rank layer 257 and the output layer 259, is equal to r×(n₅)²+n₆×r². For

$$r \leq \frac{{n}_{5} \times {n}_{6}}{{n}_{5} + {n}_{6}} ,$$

the reduction in the number of multiplications, e.g., γ, in processing each input data tuple, as a result of employing low-rank matrix multiplication, satisfies

$$γ \geq \frac{{( {n}_{5} )}^{3} \times {( {n}_{6} )}^{2}}{{( {n}_{5} + {n}_{6} )}^{2}} .$$

Given that during the training phase a huge training data set, e.g., a large number of input data tuples, is typically used, such significant reduction in computational complexity leads to a significant reduction in training phase time.

A person skilled in the art should appreciate that the entries of the matrices described above, e.g., C_{I,1}, C_{1,2}, C_{5,T}, C_{T,O, and} C_{5,6}, are equal to respective weighting coefficients. For example, C_{1,2}(i,j), the (i,j) entry of the matrix C_{1,2}, is equal to the weighting coefficient associated with the output of the j-th node of the first hidden layer 251 that is fed to the i-th node of the second hidden layer 252. That is,

$$[ \begin{matrix}{x}_{2 , 1} \\ ⋮ \\ {x}_{2 , n}\end{matrix} ] = [ \begin{matrix}{C}_{1 , 2} ( 1 , 1 ) & … & {C}_{1 , 2} ( 1 , n ) \\ ⋮ & ⋱ & ⋮ \\ {C}_{1 , 2} ( n , 1 ) & … & {C}_{1 , 2} ( n , n )\end{matrix} ] \cdot [ \begin{matrix}{y}_{1 , 1} \\ ⋮ \\ {y}_{1 , n}\end{matrix} ] ,$$

where, y_{1,1}, . . . , y_{1,n}, represent the output values of the nodes of the first hidden layer, and x_{2,1}, . . . , x_{2,n} represent summations of multiplications of input values to nodes of the second hidden layer with corresponding weighting coefficients. Once the values x_{2,1}, . . . , x_{2,n} are computed, a non-linear activation function is then applied to each of them to generate to outputs of the nodes of the second hidden layer, e.g., y_{2,1}, . . . , y_{2,n}. For example, y_{2,k}=tanh(x_{2,k}+bₖ) where the value bₖ represents a bias parameter associated with the k-th node of the second hidden layer and tanh is the hyperbolic tangent function. The letters “I”, “T”, and “0” refer, respectively, to the input data 215, the low-rank layer 257, and the output layer 259. The low-rank layer, 227 or 257, and the corresponding nodes 223 therein are the result of the low-rank matrix factorization process. The nodes of the low-rank layer 257 may be viewed as virtual nodes of the DBN since no activation function is applied therein. In fact, in terms of implementation, the computational operations, e.g., multiplications of input data values with weighting coefficients and evaluation of activation function(s), are the processing elements characterizing the complexity of the DBN 125. According to at least one example embodiment, the applying low-rank matrix factorization results in substantial reduction in computational complexity and training time for the DBN 125.

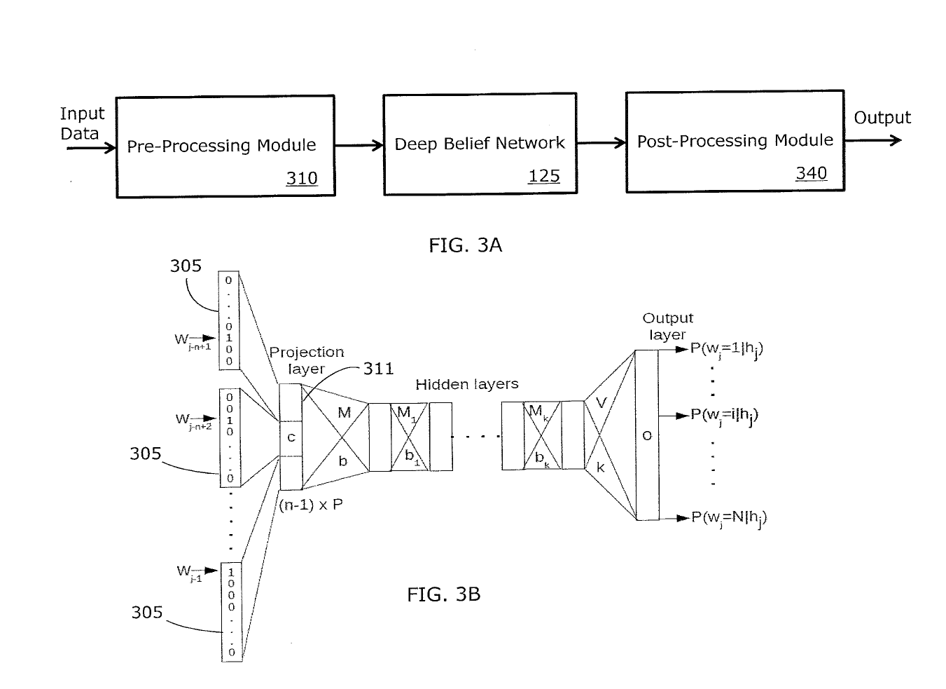

FIG. 3A shows a block diagram illustrating potential pre- and post-processing of, respectively, input and output data. DBNs may be applied in different applications such as speech recognition, language modeling, image processing applications, or the like. Given the difference between input data across different potential applications, a pre-processing module 310 may be employed to arrange input data into a format compatible with a given DBN 125. In addition, a post-processing module 340 may also be employed to transform output data by the DBN 125 into a desired format. For example, given output probability values provided by the DBN, the post-processing module 340 may be selector configured to select a single output target based on the provided output probabilities.

FIG. 3B shows a diagram illustrating a neural network language model architecture according to one or more example embodiments. Each word in a vocabulary is represented by a N-dimensional sparse vector 305 where only an index of a corresponding word is 1 and the rest of the entries are 0. The input to the network is, typically, one or more N-dimensional sparse vectors representing one or more words in the vocabulary. Specifically, representations of words (n-grams) corresponding to a context of a particular word are provided as input to the neural network. Alternatively, words in the vocabulary, or the corresponding N-dimensional sparse vectors, may be referred to through indices that are provided as input to the network. Each word is mapped to a continuous space representation using a projection layer 311. Discrete to continuous space mapping may be achieved, for example, through a look-up table with P×N entries where N is the vocabulary size and P is the feature dimension. For example, the i-th column of the table corresponds to the continuous space feature representation of the i-th word in the vocabulary. For example, by concatenating the continuous feature vectors of the words in the vocabulary as columns of a given matrix, the projection layer may be implemented as a multiplication of the given matrix with the input N-dimensional sparse vectors. If indices associated with the words in the vocabulary are used as input values, at the projection layer corresponding column(s) of the given matrix are extracted and used as respective continuous feature vector(s). The projection layer 311, of FIG. 3B, illustrates an example implementation of the pre-processing module 310.

Output feature vectors of the projection layer 311 are fed, as input data tuples, to a first hidden layer among one or more hidden layers 325. At each hidden layer, among the one or more hidden layers 325, input data values are multiplied with corresponding weighting coefficients and an activation function, e.g., a hyperbolic tangent non-linear function, is applied, for example, to the sum of weighted input data values at each node of the hidden layers 325.

In FIG. 3B low-rank matrix factorization is applied as illustrated with regard to FIGS. 2A and 2B, even though FIG. 3B does not show a low-rank layer. At the output layer 327, input data values are weighted by corresponding weighting coefficients and an activation function, e.g., a softmax function, is applied to the sum of weighted input data values. In the case of language modeling, the output values, P(wⱼ=i|hⱼ), represent a language model posterior probabilities for words in the output vocabulary given a particular history, hⱼ. The weighting of input data values and the summation of weighted input data values at nodes of a particular layer may be described with a matrix vector multiplication. The entries within a given row of the matrix correspond to weighting coefficients associated with a node, corresponding to the given row, of the particular layer. The entries of the vector correspond to input data values fed to each node of the particular layer. In FIG. 3B, c represents the linear activation in the projection layer, e.g., the process of generating continuous feature vectors. The matrix M represents the weight matrix between the projection layer and the first hidden layer, whereas the matrix Mₖ represents the weight matrix between hidden layer k and hidden layer k+1. The matrix V represents the weight matrix between the hidden last layer and the output layer. The vectors b, b₁, bₖ and K are bias vectors with bias parameters used in evaluating the activation functions at nodes of the hidden and output layers. Standard back-propagation algorithm is used to train the model.

When employing low-rank matrix factorization in designing a DBN 125, the value r is chosen in a way that would substantially reduce the computational complexity without degrading the performance of the DBN 125, compared to a corresponding DBN not employing low-rank matrix factorization. Consider, for example, a typical neural network architecture for speech recognition, as known in the art, having five hidden layers, each with, for example, 1,024 nodes or hidden units, and an output layer with 2,220 nodes or output targets. According to at least one example embodiment, employing low-rank matrix factorization leads to replacing a matrix vector multiplication C_{5,6}·u₅ by two corresponding matrix-vector multiplications C_{5,T}·u₅ and C_{T,O}·u_{T}, where C_{5,6} represents the weighting coefficients matrix associated with the output layer, e.g., 6^{th} layer, of a DBN not employing low-rank matrix factorization and u₅ represents a vector of output values of the fifth hidden layer. The vector u₅ is the input data vector to each node of the output layer. The matrices C_{5,T} and C_{T,O} represent, respectively, the weighting coefficients matrices associated with the low-rank layer, 227 or 257, and the output layer, 229 or 259, respectively. The vector u_{T} represents an output vector of the low-rank layer, 227 or 257, and is fed as input vector to each node of the output layer, 229 or 259.

According to an example embodiment, the multiplication of the matrices C_{5,T} and C_{T,O} is approximately equal to the matrix C_{5,6}, i.e., C_{5,6}≅C_{5,T}·C_{T,O}. In other words, by choosing an appropriate value for r, a DBN employing low-rank matrix factorization may be designed or configured, to have lower computational complexity but substantially similar, or even better, performance than a corresponding typical DBN, as known in the art, not employing low-rank matrix factorization. According to at least one example embodiment, a value of r may be estimated through computer simulations of the DBN.

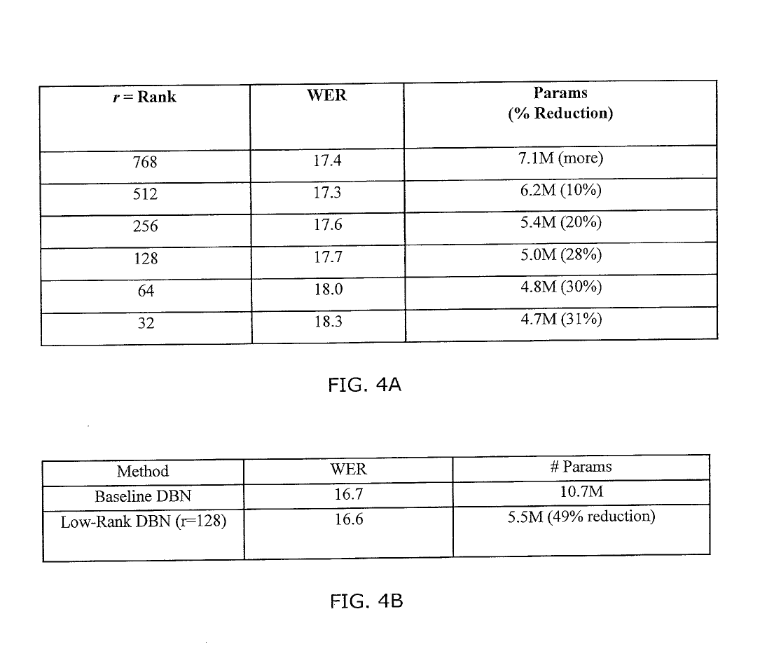

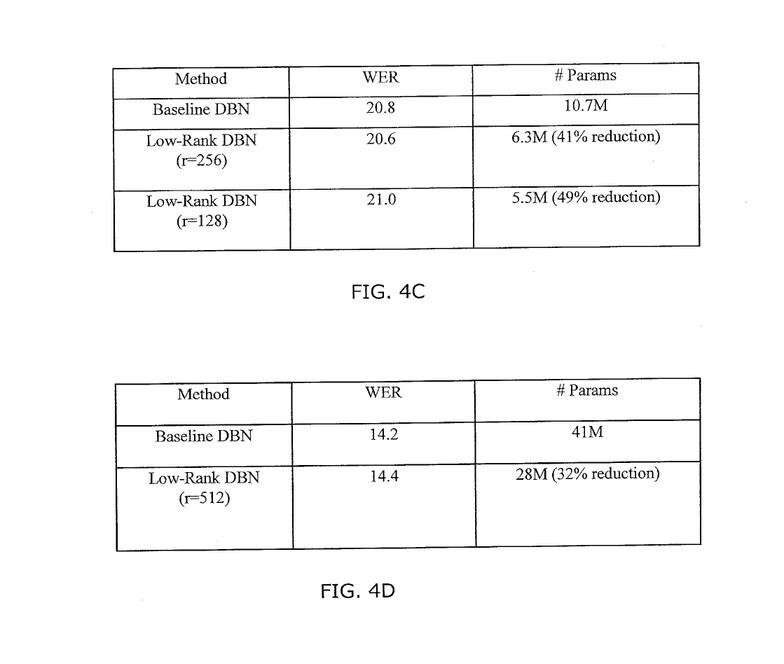

FIGS. 4A-4D show speech recognition simulations results for a baseline DBN and a DBN employing low-rank matrix factorization. The simulation results correspond to a baseline DBN architecture having five hidden layers, each with 1,024 nodes or hidden units, and an output, or softmax, layer having 2,220 nodes or output targets. In the simulation results shown in FIG. 4A, different choices of r are explored for fifty hours of training speech data known as a 50 hour English Broadcast News task. The baseline DBN includes about 6.8 million parameters and has a word-error-rate (WER) of 17.7% on the Dev-04f test set, a development/test set known in the art and typically used to evaluate the models trained on English Broadcast News. The Dev-04f test set includes English Broadcast News audio data and the corresponding manual transcripts.

In the low-rank experiments, the final layer matrix, e.g., C_{5,6}, of size 1,024×2,220, is divided into two matrices, one of size 1,024×r, e.g., C_{5,T}, and one of size r×2,220, e.g., C_{T,O}. The simulation results of FIG. 1 show the WER for different choices of the rank r and the percentage reduction in the number of parameters compared to a corresponding baseline DBN system, i.e., a DBN not employing low-rank matrix factorization. The table shows that, for example, with a r=128, the same WER of 17.7% as the baseline system is achieved while reducing the number of parameters of the DBN by 28%.

In order to show that the low-rank matrix factorization may be generalized on different sets of training data, the performance of a DBN with low-rank matrix factorization, compared to the performance of the corresponding baseline DBN, is tested using three other data sets, which have an even larger number of output targets. The results shown in FIG. 4B correspond to training data known as four hundred hours of a Broadcast News task. The baseline DBN architecture includes five hidden layers, each with 1,024 nodes or hidden units, and an output, or softmax, layer with 6,000 nodes or output targets. The simulation results shown in FIG. 4B illustrate that for r=128, the DBN with low rank matrix factorization achieves a substantially similar performance, e.g., WER=16.6, compared to WER=16.7 for the corresponding baseline DBN, while the DBN with low-rank matrix factorization is characterized by a 49% reduction in the number of parameters, e.g., 5.5 million parameters versus 10.7 million parameters in the baseline DBN.

The results shown in FIG. 4C show simulation results using training data known as three hundred hours of a Voice Search task. The baseline DBN architecture includes five hidden layers, each with 1,024 nodes or hidden units, and an output, or softmax, layer with 6,000 nodes or output targets. For r=256, WER=20.6 for the DBN employing low-rank matrix factorization, and WER=20.8 for the corresponding baseline DBN, while the DBN employing low-rank matrix factorization achieves a 41% reduction in the number of parameters, e.g., 6.3 million parameters versus 10.7 million parameters in the baseline DBN. For r=128, WER=21.0 for the DBN employing low-rank matrix factorization, slightly higher than WER=20.8 for the corresponding baseline DBN, while the DBN employing low-rank matrix factorization achieves 49% reduction in the number of parameters, e.g., 5.5 million parameters versus 10.7 million parameters in the baseline DBN.

The results in FIG. 4D show simulation results using training data known as three hundred hour of a Switchboard task. The baseline DBN architecture includes six hidden layers, each with 2,048 nodes or hidden units, and an output, or softmax, layer with 9,300 nodes or output targets. For r=512, WER=14.4 for the DBN employing low-rank matrix factorization, and WER=14.2 for the corresponding baseline DBN, while the DBN employing low-rank matrix factorization achieves a 32% reduction in the number of parameters, e.g., 628 million parameters versus 41 million parameters in the baseline DBN.

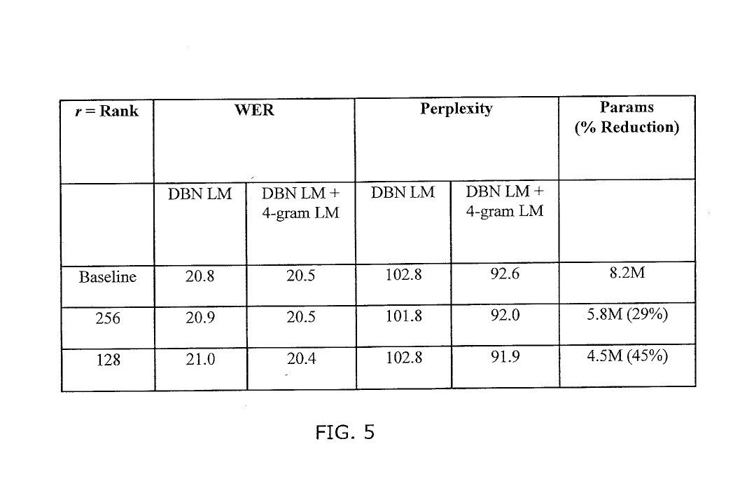

FIG. 5 shows language modeling simulation results for a baseline DBN and a DBN employing low-rank matrix factorization. The baseline DBN architecture includes one projection layer where each word is represented with 120 dimensional features, three hidden layers, each with 500 nodes or hidden units, and an output, or softmax, layer with 10,000 nodes or output targets. The language model training data includes 900K sentences, e.g., about 23.5 million words. Development and evaluation sets include 977 utterances, e.g., about 18K words, and 2,439 utterances, e.g., about 47K words, respectively. Acoustic models are trained on 50 hours of Broadcast news. Baseline 4-gram language models trained on 23.5 million words result in WER=20.7% on the development set and WER=22.3% on the evaluation set. DBN language models are evaluated using lattice re-scoring. The performance of each model is evaluated using the model by itself and by interpolating the model with the baseline 4-gram language model. The baseline DBN language model yields WER=20.8% by itself and WER=20.5% after interpolating with the baseline 4-gram language model.

In the low-rank matrix factorization experiments, the final layer matrix of size 500×10,000 is replaced with two matrices, one of size 500×r and one of size r×10,000. The results in FIG. 5 show both the perplexity, an evaluation metric for language models, and WER on the evaluation set for different choices of the rank r and the percentage reduction in parameters compared to the baseline DBN system. Perplexity is usually calculated on the text data without the need of a speech recognizer. For example, perplexity may be calculated as the inverse of the (geometric) average probability assigned to each word in the test set by the model. The results clearly show that the number of parameters is reduced without any significant loss in WER and perplexity. With r=128 in the interpolated model, almost the same WER and perplexity are achieved as the baseline system, with a 45% reduction in the number of parameters.

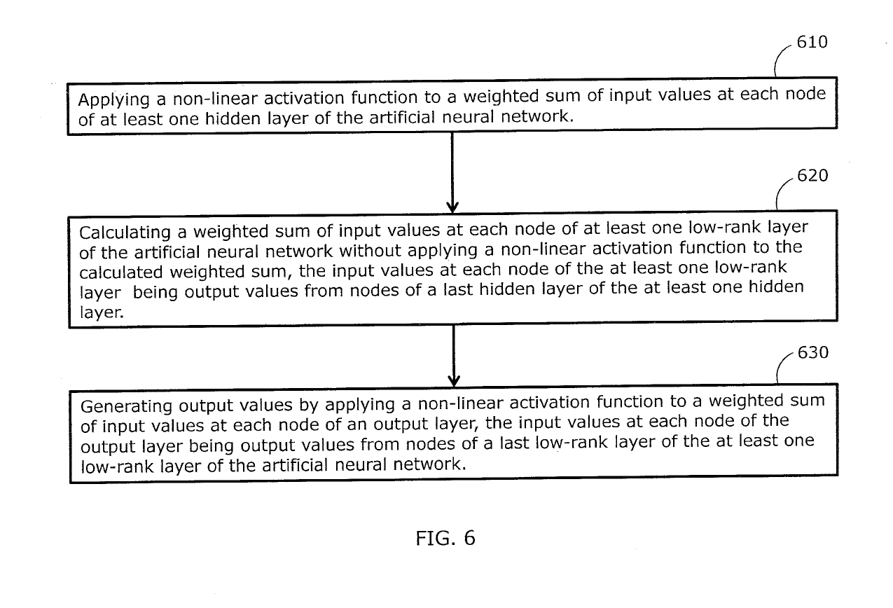

FIG. 6 is a flow chart illustrating a method of processing data, representing a real-world phenomenon, using an artificial neural network configured to model a real-world system or data pattern according to at least one example embodiment. At block 610, a non-linear activation function is applied to weighted sum of input values at each node of the at least one hidden layer of the artificial network. The weighted sum is computed, for example, as the sum of input values multiplied by corresponding weighting coefficients. Block 320 describes the processing associated with each node of a low-rank layer of the artificial network, where a weighted sum of respective input values is calculated without applying a non-linear activation function to the calculated weighted sum. In other words, at a node of the low-rank layer, input values are weighted through multiplication with respective weighting coefficients. The sum of weighted input values is calculated to generate the weighted sum. At the node of the low-rank layer, no non-linear activation function is applied to the calculated weighted sum. The calculated weighted sum is provided as the output of the node of the low-rank layer. The input values to nodes of the low-rank layer are output values from nodes of a last hidden layer. According to an example embodiment, the artificial neural network may include more than one low-rank layer, e.g., two or more low-rank layers are applied in sequence between the last hidden layer and the output layer of the artificial neural network. In such case, the output values from nodes of a low-rank layer are fed as input values to nodes of another low-rank layer of the sequence. At block 630, output values are generated by applying a non-linear activation function to a weighted sum of input values at each node of the output layer, the weighted input values at each node of the output layer being output values from nodes of a last low-rank layer of the at least one low-rank layer of the artificial neural network.

It should be understood that the example embodiments described above may be implemented in many different ways. In some instances, the various methods and machines described herein may each be implemented by a physical, virtual or hybrid general purpose computer having a central processor, memory, disk or other mass storage, communication interface(s), input/output (I/O) device(s), and other peripherals. The general purpose computer is transformed into the machines that execute the methods described above, for example, by loading software instructions into a data processor, and then causing execution of the instructions to carry out the functions described, herein.

As is known in the art, such a computer may contain a system bus, where a bus is a set of hardware lines used for data transfer among the components of a computer or processing system. The bus or busses are essentially shared conduit(s) that connect different elements of the computer system, e.g., processor, disk storage, memory, input/output ports, network ports, etc., that enables the transfer of information between the elements. One or more central processor units are attached to the system bus and provide for the execution of computer instructions. Also attached to system bus are typically I/O device interfaces for connecting various input and output devices, e.g., keyboard, mouse, displays, printers, speakers, etc., to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein constitute a computer program product, including a computer readable medium, e.g., a removable storage medium such as one or more DVD-ROM's, CD-ROM's, diskettes, tapes, etc., that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transitory machine-readable medium, which may be read and executed by one or more processors. A non-transient machine-readable medium may include any mechanism for storing or transmitting information in a form readable by a machine, e.g., a computing device. For example, a non-transient machine-readable medium may include read only memory (ROM); random access memory (RAM); magnetic disk storage media; optical storage media; flash memory devices; and others.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It also should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and, thus, the data processors described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A computer-implemented method of processing data, representing a real-world phenomenon, using an artificial neural network configured to model a real-world system or data pattern, the method comprising:
applying a non-linear activation function to a weighted sum of input values at each node of at least one hidden layer of the artificial neural network;
calculating a weighted sum of input values at each node of at least one low-rank layer of the artificial neural network without applying a non-linear activation function to the calculated weighted sum, the input values at each node of the at least one low-rank layer being output values from nodes of a last hidden layer of the at least one hidden layer; and
generating output values by applying a non-linear activation function to a weighted sum of input values at each node of an output layer, the input values at each node of the output layer being output values from nodes of a last low-rank layer of the at least one low-rank layer of the artificial neural network.

2. The computer-implemented method of claim 1, wherein the at least one low-rank layer and associated weighting coefficients are obtained by applying an approximation, using low rank matrix factorization, to weighting coefficients interconnecting the last hidden layer to the output layer in a baseline artificial neural network that does not include the at least one low-rank layer.

3. The computer-implemented method of claim 2, wherein the number of nodes of the at least one low-rank layer is fewer than the number of nodes of the last hidden layer.

4. The computer-implemented method of claim 1 further comprising:
adjusting weighting coefficients associated with nodes of the at least one hidden layer, the at least one low-rank layer, and the output layer based at least in part on outputs of the artificial neural network and training data.

5. The computer-implemented method of claim 4, wherein adjusting weighting coefficients includes using a fine-tuning approach or a back-propagation approach.

6. The computer-implemented method of claim 1, wherein the generated output values are indicative of probability values corresponding to a plurality of classes, the plurality of classes being represented by the nodes of the output layer.

7. The computer-implemented method of claim 1, wherein the artificial neural network is a deep belief network.

8. The computer-implemented method of claim 1, wherein the data includes speech data and the artificial neural network is used for speech recognition.

9. The computer-implemented method of claim 1, wherein the data includes text data and the artificial neural network is used for language modeling.

10. The computer-implemented method of claim 1, wherein the data includes image data and the artificial neural network is used for image processing.

11. An apparatus for processing data, representing a real-world phenomenon, using an artificial neural network configured to model a real-world system or data pattern, the apparatus comprising:
at least one processor; and
at least one memory with computer code instructions stored thereon,
the at least one processor and the at least one memory with the computer code instructions being configured to cause the apparatus to perform at least the following:
apply a non-linear activation function to a weighted sum of input values at each node of at least one hidden layer of the artificial neural network;
calculate a weighted sum of input values at each node of at least one low-rank layer of the artificial neural network without applying a non-linear activation function to the calculated weighted sum, the input values at each node of the at least one low-rank layer being output values from nodes of a last hidden layer of the at least one hidden layer; and
generate output values by applying a non-linear activation function to a weighted sum of input values at each node of an output layer, the input values at each node of the output layer being output values from nodes of a last low-rank layer of the at least one low-rank layer of the artificial neural network.

12. The apparatus of claim 11, wherein the at least one low-rank layer and associated weighting coefficients are obtained by applying an approximation, using low rank matrix factorization, to weighting coefficients interconnecting the last hidden layer to the output layer in a baseline artificial neural network that does not include the at least one low-rank layer.

13. The apparatus of claim 12, wherein the number of nodes of the at least one low-rank layer is fewer than the number of nodes of the last hidden layer.

14. The apparatus of claim 11, wherein the at least one processor and the at least one memory, with the computer code instructions, being further configured to cause the apparatus to:
adjust weighting coefficients associated with nodes of the at least one hidden layer, the at least one low-rank layer, and the output layer based at least in part on outputs of the artificial neural network and training data.

15. The apparatus of claim 14, wherein adjusting weighting coefficients includes using a fine-tuning approach or a back-propagation approach.

16. The apparatus of claim 11, wherein the generated output values are indicative of probability values corresponding to a plurality of classes, the plurality of classes being represented by the nodes of the output layer.

17. The apparatus of claim 11, wherein the artificial neural network is a deep belief network.

18. The apparatus of claim 11, wherein the data includes speech data and the artificial neural network is used for speech recognition.

19. The apparatus of claim 11, wherein the data includes text data and the artificial neural network is used for language modeling.

20. A non-transitory computer-readable medium with computer code instructions stored thereon, the computer code instructions when executed by a processor, cause an apparatus to perform at least the following:
applying a non-linear activation function to a weighted sum of input values at each node of at least one hidden layer of an artificial neural network;
calculating a weighted sum of input values at each node of at least one low-rank layer of the artificial neural network without applying a non-linear activation function to the calculated weighted sum, the input values at each node of at least one low-rank layer being output values from nodes of a last hidden layer of the at least one hidden layer; and
generating output values by applying a non-linear activation function to a weighted sum of input values at each node of an output layer, the input values at each node of the output layer being output values from nodes of a last low-rank layer among the at least one low-rank layer of the artificial neural network.
